(19) United States
(12) Patent Application Publication
(10) Pub. No.: US 2018/0039329 A1
(43) Pub. Date: Feb. 8, 2018

(54) BRAIN ACTUATED CONTROL UTILIZING VISUALLY EVOKED POTENTIALS

(71) Applicant: David M. Tumey, Coral Springs, FL (US)

(72) Inventor: David M. Tumey, Coral Springs, FL (US)

(21) Appl. No.: 15/666,443

(22) Filed: Aug. 1, 2017

Related U.S. Application Data
(60) Provisional application No. 62/371,176, filed on Aug. 4, 2016.

(51) Int. Cl. G06F 3/01; G06Q 30/06

(52) U.S. Cl. CPC G06F 3/015; G06Q 30/0643

(57) ABSTRACT

A brain-to-computer interface providing brain actuated control of hardware or software associated with said computer is effected by releasably attaching a plurality of high-impedance dry Ag/Ag—Cl electrodes to selected locations on a human user's scalp; providing a low-noise, high-gain, instrumentation amplifier electrically associated with said plurality of electrodes; utilizing a high-resolution Analog-to-Digital (A/D) converter electrically associated with said instrumentation amplifier and said computer to digitize electroencephalographic signals detected by said plurality of electrodes; and, analyzing said digitized electroencephalographic signals utilizing a computer algorithm to detect steady-state evoked potentials in response to visual stimuli for use in providing control inputs to said hardware or software.

### FIELD OF THE INVENTION

The present invention relates to a brain-to-computer interface. More particularly, the invention relates to a system for providing brain-actuated control of hardware or software associated with said computer by measuring and analyzing a human user's electroencephalographic steady-state evoked potentials generated from visual stimuli and providing a response thereto.

### BACKGROUND OF THE INVENTION

The terms visually evoked potential (VEP), visually evoked response (VER) and visually evoked cortical potential (VECP) are equivalent. They refer to electrical potentials, initiated by brief visual stimuli, which are recorded from the scalp overlying the visual cortex, Historically, VEP waveforms have been extracted from the electro-encephalogram (EEG) by signal averaging. VEPs are used primarily to measure the functional integrity of the visual pathways from the retina via the optic nerves to the visual cortex of the brain. VEPs better quantify functional integrity of the optic pathways than scanning techniques such as magnetic resonance imaging (MRI).

Any abnormality that affects the visual pathways or visual cortex in the brain can affect the VEP. Examples are cortical blindness due to meningitis or anoxia, optic neuritis as a consequence of demyelination, optic atrophy, stroke, and compression of the optic pathways by tumors, amblyopia, and neurofibromatosis. In general, myelin plaques common in multiple sclerosis slow the speed of VEP wave peaks. Compression of the optic pathways such as from hydrocephalus or a tumor also reduces amplitude of wave peaks.

Stead-state visually evoked potentials (SSVEP) or steady-state evoked potentials (SSEP) are created by repeating VEP stimuli at a fixed periodic rate. In neurology, SSEP are signals that are natural responses to visual stimulation at specific frequencies. When the retina is excited by a visual stimulus ranging from approximately 3.5 Hz to 75.0 Hz, the visual cortex of the brain generates electrical activity at the same, or multiples of, the frequency of the visual stimulus.

Likewise, this technique is used widely with electroencephalographic research regarding vision. SSEP's are useful in research because of the excellent signal-to-noise ratio and relative immunity to artifacts (such as muscle or motion artifacts). SSEP's also provide a means to characterize preferred frequencies of neocortical dynamic processes. SSEP is generated by stationary localized sources and distributed sources that exhibit characteristics of wave phenomena.

### History

VEPs initiated by strobe flash were noticed in the early years of clinical encephalography (EEG) in the 1930s. A VEP can often be seen in the background EEG recorded from the occipital scalp following a flash of light. Evoked potentials, whether auditory, visual or somatosensory, are extracted from the EEG by a simple program. This technique of extracting a signal from random noise is one of the oldest applications of computer technology. This process is similar to programs used to extract radar signals from jamming nearly 70 years ago. Adding the electrical activity for set time periods is called “signal averaging”. Dawson first demonstrated a signal-averaging device in 1951 and signal-averaging computers have been available since the early 1960s. The computer programs save a defined time period of EEG activity following a visual stimulus, which is repeated over and over adding the signals together. The random EEG activity averages away, leaving the visually evoked potential. Depending on the signal to noise ratio, an evoked potential can be seen forming following only a few stimuli such as flashes of light.

Similarly, an SSEP can be extracted from noisy data in myriad ways utilizing digital computer algorithms. For example, a “lock-in” amplifier can be designed such that its output is function of the power spectrum for a given frequency of interest. In this case, a visual stimulus repeating at the design frequency of the lock-in amplifier is provided and the amplified EEG signal processed by the lock-in amplifier to generate a signal the strength of which correlates with the strength of the SSEP at the occipital lobe of the brain.

### Electrode Locations on the Scalp

Visually evoked potentials elicited by flash stimuli can be recorded from many scalp locations in humans. Visual stimuli stimulate both primary visual cortices and secondary areas. Clinical VEPs are usually recorded from the occipital scalp region overlying the calcarine fissure. This is the closest location to the primary visual cortex (Brodmann's area 17). A common system for designating the placement of electrodes is the “10-20 International System” which is based on measurements of head size. The mid-occipital electrode location (OZ) is on the midline. The distance above the inion calculated as 10% of the distance between the inion and nasion, which is 3-4 cm in most adults. The inion is the most prominent projection of the occipital bone at the posterioinferior (lower rear) part of the skull. Lateral occipital electrodes are a similar distance off the midline. Another set of locations is the “Queen Square system” in which the mid-occipital electrode is placed 5 cm above the inion on the midline and 5 cm lateral from that location for lateral occipital electrodes. The Queen Square locations, further off the midline, are better able to lateralize anomalies such as when using hemi-field stimulation. Some laboratories, and unique applications, have other preferred scalp locations.

Many laboratories record from an array of locations placed horizontally across the occipital scalp region in an attempt to lateralize pathology. Other laboratories use only a single positive midline recording electrode at OZ with one earlobe as negative location and the other earlobe as ground location. A second montage is necessary for recording multifocal visually evoked potentials (mfVEPs). A common mfVEP montage is to place two electrodes on the midline one just below the inion and another 3 centimeters above the inion; and laterally place electrodes 3-4 centimeters off the midline several centimeters above the inion.

### Sources of Visual Evoked Potentials

Most of the primary visual cortex in humans is located in fissures, not on the cortical surface of the occipital pole. At most, only about the central 10 degrees of visual field are located on the surface of the occipital pole. Furthermore, the area located on the surface of the occipital pole is quite variable, even between hemispheres of the same individual. Because most electrical potentials are generated in sulci, simultaneously at multiple locations, and because of the vertical cancellation that occurs between upper and lower fields, lateralization of pathology is difficult. Potentials occurring at different cortical locations in vertical and horizontal planes that vary between hemispheres produce paradoxical lateralization and obscures source localization.

A common way to generate a visual stimulus for inducing the VEP or SSEP phenomena is foveal pattern reversal stimulation. A typical pattern stimulus comprises a small 5-degree field composed of 64 square checks each 36′ of arc reversing at 2/second. In VEP as well as SSEP maximum electroencephalographic (EEG) activity generally appears in the lateral geniculate nucleus, occipital cortex and inferior temporal cortical areas of the brain during foveal pattern reversal stimulation.

The neural generators of the waves of the visual evoked potential (VEP) are not clearly defined. Research with multichannel scalp recordings, visual MRI activity and dipole modeling, supports the interpretation that the visual cortex is the source of the early components of the VEP (N1, N70) prior to P1 (“P100”). The early phase of the P1 component with a peak around 95-110 msec, is likely generated in dorsal extrastriate cortex of the middle occipital gyrus. The later negative component N2 (N150) is generated from several areas including a deep source in the parietal lobe.

As can be seen in functional visual MRIs, brain activity varies considerably in the occipital area. A number of dipole fields are generated resulting in a complicated interaction. These multiple sites of generators interact at different levels in the visual areas making source localization difficult when making individual clinical decisions. Because of individual idiosyncrasies in occipital anatomy and visual projections, one cannot make the assumptions about sources that one can using electroretinograms or auditory brainstem responses.

### VEP/SSEP Recording Methods

Typically, a reference electrode is placed on the earlobe, on the midline on top of the head or on the forehead. A ground electrode can be placed at any location, mastoid, scalp or earlobe. The time period analyzed is usually between 200 and 500 milliseconds following onset of each visual stimulus. The most common amplifier bandpass frequency limits are 1 Hz and 100 Hz. Amplifier sensitivity settings vary with +/−10 uV common for adult human subjects. Sometimes the sensitivity setting must be changed to accommodate larger EEG voltage in all age groups. Commonly used visual stimuli are strobe flash, flashing light-emitting diodes (LEDs), variable intensity fluorescent lights, transient and steady state pattern reversal and pattern onset/offset.

A common visual stimulus used is a checkerboard pattern, which reverses every half-second. Pattern reversal is a preferred stimulus because there is more inter-subject VEP reliability than with flash or pattern onset stimuli. Several laboratories developed pattern reversal visual stimuli in the 1970s including A. M. Halliday at Queen Square in London and Lorrin A. Riggs at Brown University. Originally Halliday back-projected a checkerboard pattern onto a translucent screen with two projectors that each projected reversed checkerboard images. Camera shutters on each projector controlled the display of each checkerboard reversing at a rate 2 per second. Riggs originally projected alternating vertical stripes using a reversing mirror system. Commercially produced visual evoked potential systems simulating these pattern reversals now use video monitors and computer generated images.

When using computer generated images nearly every subject with close to normal visual function produces a similar evoked potential using pattern reversal stimuli. There is a prominent negative component at peak time of about 70 msec (N1), a larger amplitude positive component at about 100 msec (P1) and a more variable negative component at about 140 msec (N2). The major component of the VEP is the large positive wave peaking at about 100 milliseconds This “P100” or P1 in the jargon of evoked potentials, is very reliable between individuals and stable from about age 5 years to 60 years. The mean peak time of the “P100” only slows about one millisecond per decade from 5 years old until 60 years old.

Video monitors that produce brighter, faster changing patterns such as liquid crystal displays (LCD) evoke faster VEPs than cathode ray tube video monitors. The “P100” or P1 component is much faster using liquid crystal displays (LCD) evoking P1 peak times of less than 90 milliseconds.

The size of each check in the pattern and size of the visual field affects the VEP. Most laboratories initially screen patients using a video display with field subtending 10-40 degrees of arc and fairly large individual check size of about 1 degree of arc. A large check size is used because most clinical laboratories are recording from patients who lack good visual acuity. The largest amplitude, fastest peak time VEP is recorded using the smallest check size the subject can see sharply. A person with 20/20 (6/6) or better vision will produce the largest amplitude, fastest VEP components using a small check size (a visual field comprised of checks only 5-6 mm viewed at 1 meter). Each check would measure about 15-20′ of arc. A person with poor visual acuity would produce the largest amplitude, fastest components with a larger check size subtending a degree or more (such as a 20 mm check or larger viewed at 1 meter distance). This is the basis for one being able to estimate acuity by testing a subject with several check sizes. The “P100” (P1) component is sensitive to defocusing and can, therefore, be measured following stimulation with different check sizes to estimate refractive error. For most clinical screening, a single check size of about 1 degree of arc, or a little smaller, such as about 50′ of arc, is sufficient. One need not use larger checks for children. Once a child is mature enough to attend and maintain fixation their visual systems are mature enough to use the same size stimuli as adults. Also recording pattern reversal VEPs with smaller check size of approximately 0.25 degree will contribute useful information.

The VEP waveform, amplitudes and peak times depend upon the parameters of the stimulus. SSEPs are those recorded using stimulation rates of 3 or more per second. Transient VEPs are recorded using rates of less than 3 per second. Transient pattern VEPs have components that can be followed during maturation, pathological conditions and changes of acuity. Flash-evoked and pattern onset VEPs are reliable in form within the individual but vary considerably between subjects. The checkerboard pattern can also be made to appear (onset) and disappear (offset). In many individuals the pattern onset VEP is opposite in polarity compared to flash and pattern reversal VEPs. The pattern onset VEP usually includes a positive component at about 80 msec and a large negative component at about 110 msec. Another advantage of the pattern reversal VEP is that it has a smaller standard deviation for the P1 component (about 6 msec). The P110 component of the flash VEP and the N110 component of the pattern onset VER have standard deviations of about 10 msec.

### Prior Use of SSEPs in Brain Actuated Control

In the late 1980's and early 1990's researchers at the Wright Patterson, Air Force Base in Dayton Ohio developed a roll-axis tracking flight simulator that utilized a rudimentary form of brain-actuated control based on SSEPs. In this system, a pilot test subject was seated in a simulated cockpit environment mounted on an axle the rotation of which was controlled by an electric motor. A video monitor screen was located directly in front of the pilot that provided an artificial horizon indicating the relative bank angle of the simulator. Flanking the display screen were two small fluorescent lamps the intensity of each being modulated by a sinusoidal frequency generator. The depth of modulation could be varied from between about 20% and 80%. A diffuser screen was placed in front of the fluorescent lamps with a fenestration that permitted viewing of the display screen and artificial horizon. The flight simulator cockpit was also equipped with an EEG amplifier that connected to a lock-in amplifier system implemented using hardware components. The simulator's roll angle was controlled by the output of the lock-in amplifier such that if the output level was below a set threshold (indicating suppression of the SSEP), the simulator would incrementally roll to the left. In the event the lock-in amplifier output was above another set threshold (indicating enhancement of the SSEP), the simulator would incrementally roll to the right. A subject seated in the simulator would be able to manipulate the roll angle of the simulator by varying their individual response to the SSEP stimulus.

While the prior art is replete with examples of the utilization of VEP and SSEP in the diagnosis of visual and neurological pathologies and for conducting basic research into the fundamental workings of the brain, there is a dearth of prior art relating to the use of SSEPs in creating a practical functioning brain-computer interface. In the one example given above, the SSEP was utilized in a very inefficient way creating a one-dimensional signal that had significant processing delays with respect to the control requirements of the simulator (it would take many seconds to move the simulator from its maximum left bank angle to the maximum right bank angle). These types of control delays would be completely inappropriate for most VR or MR applications. Additionally, only a single SSEP stimulation frequency was used to control the machine, in contrast to the present invention which utilizes multiple SSEP stimuli to provide significantly greater multi-dimensional control opportunities. Finally, the prior art all describe apparatus for use in clinical and laboratory settings using hardware components that would be completely unsuitable for consumer applications such as a portable VR or MR control system.

It is therefore an overriding object of the present invention to improve over the prior art by providing a method and apparatus by which a brain-to-computer interface may be dramatically enhanced. It is a further object of the present invention to provide such a method and apparatus that can effect brain actuated control of hardware or software associated with said computer, for example, using the brain-derived signals to control VR and MR applications such as e-commerce, Internet browsing, electronic communications, and providing practical computer control for disabled individuals. It is yet another object of the present invention to provide such a method and apparatus that is simple to implement, requiring no bulky electronic systems, sub-systems and components and that can be integrated with existing VR and MR display headsets. Finally, it is an object of the present invention to provide such a method and apparatus wherein the user can dramatically increase their gratification and enjoyment of various VR/MR experiences by utilizing a hands-free brain-controlled interface to navigate within and control aspects of the VR/MR environments.

### SUMMARY OF THE INVENTION

In accordance with the foregoing objects, the present invention—brain actuated control utilizing steady-state evoke potentials—generally comprises releasably attaching a plurality of high-impedance dry Ag/Ag—Cl electrodes to selected locations on a human user's scalp; providing a low-noise, high-gain, instrumentation amplifier electrically associated with said plurality of electrodes; utilizing a high-resolution Analog-to-Digital (A/D) converter electrically associated with said instrumentation amplifier and said computer to digitize electroencephalographic signals detected by said plurality of electrodes; and, analyzing said digitized electroencephalographic signals utilizing a computer algorithm to detect SSEPs in response to a visual stimulus for use in providing control inputs to said hardware or software. The high-impedance electrodes could be incorporated in a stand-alone head band, or could be integrated into a Virtual Reality (VR) or Mixed Reality (MR) headgear assembly to provide convenience to the user when utilizing the system.

The high-impedance dry Ag/Ag—Cl electrodes of the present invention play an essential role in making the system easy and convenient to use. This type of electrode will be wholly preferred by the user over traditional Ag/Ag—Cl (or Au) electrodes which typically require the use of conductive gels or pastes making them difficult to both apply and remove. In order to realize this important aspect of the invention, the design and construction of the instrumentation amplifier, responsible for faithfully increasing the strength of the EEG signals received by the electrodes, is critical and must have provisions to reject noise, such as common-mode noise, interfering exogenous electrical noise and most importantly internal noise generated by the active components of the amplifier. For example, the instrumentation amplifier of the present invention should have ultra-low internal noise specifications, e.g., input referred noise≦22 nV/√Hz and input current noise≦0.13 fA/√Hz. The amplifier must also utilize front-end active components with ultra-high input impedance, low current and low capacitance (≧10̂12Ω, input current ≦25 fA, input capacitance ≦1.5 pF). Owing to the significant advances made over the past two decades in operational-amplifier design and fabrication there are many suitable amplifier components that can meet these requirements and that are commercially available and well known to anyone skilled in the relevant arts.

In addition to the stringent requirements for the high impedance Ag/Ag—Cl electrodes and instrumentation amplifier, the present invention will need to make use of a high resolution A/D converter, e.g., >16-bits and preferably 24-bits. The reason for this requirement is twofold. First, the number of bits used to digitally represent the analog signal determines the number of levels to which a signal can be resolved, for example, an A/D converter with 8-bits would be able to resolve an analog signal to 256 levels (2̂8=256) while a 24-bit A/D converter could resolve an analog signal to 16,777,216 levels (2̂24=16,777,216). In this way a higher resolution A/D allows for smaller variations in signal level to be detected and recorded; variations that would otherwise be lost between levels of a low-resolution A/D. Second, since the A/D is able to resolve tiny changes in input signal level, the gain requirement for the instrumentation amplifier is significantly reduced. As amplifier gain is increased there is typically an increase in complexity, noise, power consumption and instability. Therefore, the present invention will make use of one of the myriad high-resolution A/D integrated circuits that are commercially available and well known to anyone skilled in the relevant arts.

Because the present invention is intended to be integrated into an existing VR or MR headset in at least one embodiment, the electrodes and instrumentation amplifier described herein above will lend themselves well to this configuration. In addition, since the VR/MR headsets that are commercially available normally incorporate high-resolution display technology, the SSEP visual stimulus, such as an alternating checkerboard pattern described in detail above can readily be implemented.

The amplified and digitized signals obtained from the user's scalp by way of the VR/MR headset can be further processed by a computer in electrical communication with the A/D. The computer of the present invention can be separate from or, in the alternative, part of the computer used to generate the VR or MR environments. In any case, a lock-in amplifier system can be implemented entirely in software and utilized to analyze the digitized EEG signals enabling detection and quantization of an SSEP resulting from the above described visual stimulus. The output signal(s) from the software-derived lock-in amplifier system can be used within the VR/MR environment for operations such as navigation within and control of aspects of the simulation. By way of example, a user could make a purchase within an e-commerce VR/MR simulation by focusing on a desired item that has been encoded with an SSEP visual stimulus. When the lock-in amplifier generates an output signal indicating that the user is focusing on the specific item, a “shopping cart” could appear giving the user an option to purchase the item. The user could indicate his/her preference again by focusing on one of another SSEP stimulus, e.g., one SSEP stimulus indicating “purchase” and another SSEP stimulus indicating “cancel”. In the foregoing example, the entire commercial transaction could take place using only brain-actuated control and would not require the user to take any other action, such as using a mouse or keyboard. In fact, it is believed that a brain-actuated control method of the present invention can provide an interface that is significantly more natural than any other method with respect to a VR or MR environment.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

FIG. 1 shows a block diagram of an aspect of the present invention for brain actuated control utilizing steady-state evoked potentials.

FIG. 2 shows in flow diagram a representation of the general processing steps of the present invention.

FIG. 3 shows in exploded view a representation of the head-gear with integrated Ag/Ag—Cl electrodes utilized with the present invention.

FIG. 4 shows in functional block diagram an instrumentation amplifier and filtering system of the present invention.

FIG. 5 shows in functional block diagram a lock-in amplifier system of the present invention.

FIG. 6 shows in flow diagram a representation of the general processing steps of another aspect of the present invention for virtual e-commerce applications.

FIG. 7 shows an exemplar of a 3D representation of a virtual e-commerce application and virtual shopping cart of the present invention.

### DETAILED DESCRIPTION OF THE PREFERRED EMBODIMENT

Although those of ordinary skill in the art will readily recognize many alternative embodiments, especially in light of the illustrations provided herein, this detailed description is of the preferred embodiment of the present invention, brain actuated control utilizing steady-state evoked potentials, the scope of which is limited only by the claims appended hereto.

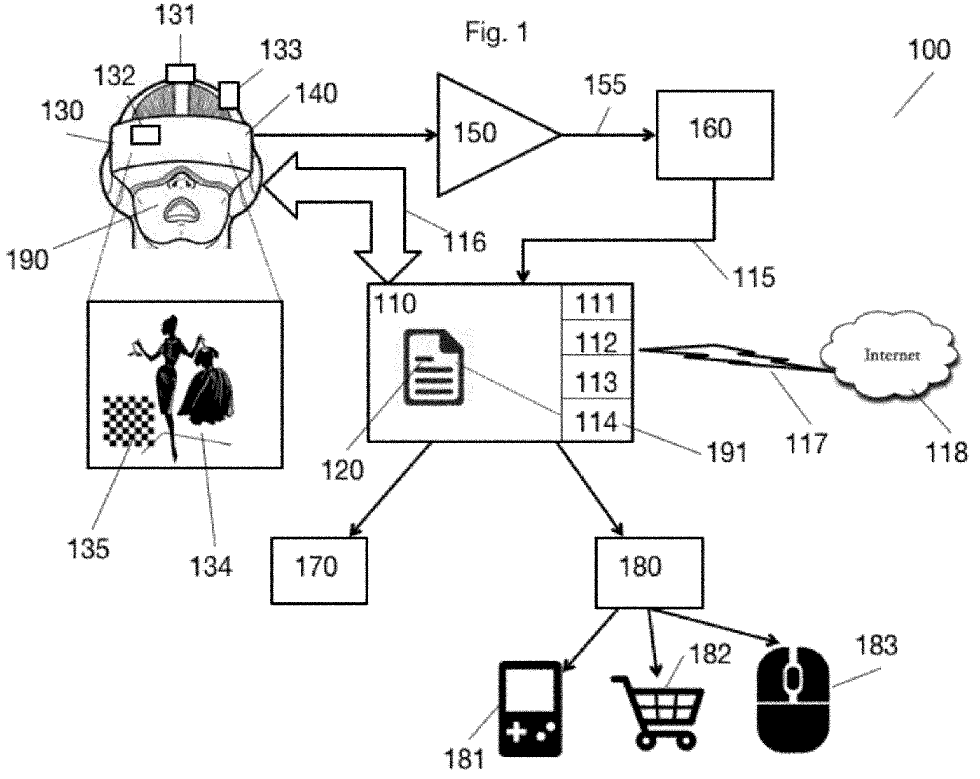

As particularly shown in FIG. 1, an apparatus for brain actuated control utilizing steady-state evoked potentials of the present invention is referred to by the numeral 100 and generally comprises a computer-based device 110, software stored within computer-based device for performing the steps of the invention 120, Virtual Reality (VR) or Mixed Reality (MR) headgear 130, integrated Ag/Ag—Cl electrode array 140, biopotential amplifier 150, Analog-to-Digital converter 160, external device to be controlled 170, and/or internal/external software application to be controlled 180.

Referring now to FIG. 1, a method and apparatus for brain actuated control utilizing steady-state evoked potentials includes a computer 110 well known in the art and commercially available under such trademarks as “IBM®”, “Compaq®”, and “Dell®” having a central processor (CP) 111 which is also well known in the art and commercially available under such trademarks as “Intel® 486”, “Pentium®” and “Motorola 68000”, conventional non-volatile Random Access Memory (RAM) 112, conventional Read Only Memory (ROM) 113, and disk storage device(s) 114. Computer 110 can be configured as a standard PC, or can be implemented as a custom single-board computer utilizing an embedded operating system such as is sold commercially under the trademark Windows NT®. Likewise, computer 110 could be a smart-phone or derivative thereof well known in the art and commercially available under the trademarks “iPhone®” and “Android®”. Computer 110 can be utilized by the present invention in a stand-along configuration, or alternatively connected to the Internet 118 via a LAN or WiFi or other electronic data-interchange connection 117, for example. Computer 110 is operably associated with communications channel 115 which can be a conventional RS-232, USB or another equivalent bi-directional communications port. Communications channel 115 has associated therewith an Analog-to-Digital converter 160 which can be one of myriad devices that are known to anyone of ordinary skill in the art. A/D converter 160 should be of a high-resolution type with not less than 8 bits and preferably 24 bits or more. The Analog-to-Digital converter 160 and communications channel 115 are responsible for converting the analog human biopotential signals into a digital representation that can be subsequently processed by computer 110. Computer 110 is further operably associated with disk storage device(s) 114 comprising a file system utilized in storing the software 120 and, if needed, human biopotential data 191. Computer 110 is also electrically associated with a MR/VR headgear device 130 which is well known in the art and available under the trademark “HoloLens®” for example. Computer 110 connects to the headgear device 130 via a second communications channel 116. This channel provides visual data to headgear device 130 to be viewed by the user. This data can include for example 3D virtual renderings of people, places or things 134. Additionally, communications channel 116 connects various position tracking sensors including a head tracking sensor 131, eye tracking sensor 132 and optionally GPS sensor 133 to computer 110. Headgear device 130 typically has associated with it a high-resolution monitor such as an LCD, LED or other display device, all of which are well known in the art, said monitor designed to present images to a human subject 190. Headgear device 130 has a plurality of Ag/Ag—Cl electrodes 140 integrated therewith wherein said electrodes 140 are removably associated with said human subject 190 the particulars of which are described hereinafter. A biopotential amplifier 150 and an analog communications channel 155 which transmits three analog data types (EEG, EOG and EMG) is electrically associated with the Analog-to-Digital converter 160. Biopotential amplifier 150, communications channel 155 and Analog-to-Digital converter 160 can comprise one or more channel. The preferred embodiment of the present invention includes at least two channels. Collectively, these elements (150-160) can be housed within headgear 130 to minimize the bulk and complexity of the system or can be remotely located from headgear 130. Headgear device 130 also has the capability of projecting one or more visual stimuli 135, which in the example depicted is a checkerboard pattern described in detail herein above. Visual stimuli 135 is configured to be a steady-state visual stimuli designed to generate an SSEP (detected by electrode array 140 and biopotential amplifier 150) in the event subject 190 is focused on one or more of said stimuli 135. Stimuli 135 can be associated with one or more people, places or things 134 to enable, for example, user 190 to select one or more of said people, places or things by producing an SSEP in response to said stimuli 135. In this way, the user 190 can effect brain actuated control on a device 170 or software application 181. The device 170 of the present invention could be any electromechanical device or instrument, for example an electronic musical keyboard, communication signaling device, media device, gaming device, or even another computer. Software application 180 of the present invention could be any type of software program including, for example, a video game or other electronic game 181, an e-commerce or other application 182 or a computer pointing device 183. It should be noted that video game 181, e-commerce application 182 or computer pointing device 183 could all be part of a virtual or mixed reality simulation. By way of example utilizing an e-commerce application 182, headgear 130 could project a virtual or mixed reality shopping mall with a commercial offering such as a dress or other article of clothing 134 along with an associated steady-state stimulus 135 that would be viewed by user 190 who is wearing the headgear and accessing the e-commerce site 182. A user 190 could focus his/her attention on said stimulus 135 indicating an interest in commercial offering 134 which subsequently would signal the computer 110 to place the offering 134 into a shopping cart for later purchase. It is readily apparent based on this example that the brain actuated control system 100 depicted in FIG. 1 could effect many forms of brain actuated control in this way including causing locomotion within a virtual environment, selecting and purchasing commercial offerings, touring virtual environments and requesting information about a person, place or thing associated with said virtual environment.

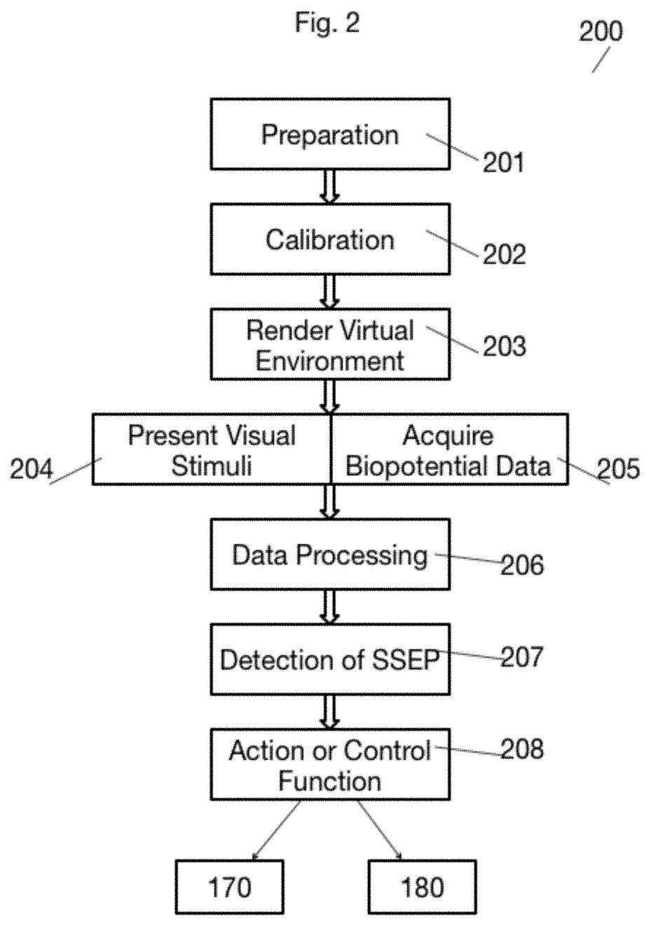

As shown in FIG. 2, the general processing steps 200, appropriate for implementation of the present invention includes preparation step 201, calibration step 202, rendering virtual environment step 203, associating and presenting steady-state stimuli step 204, acquiring biopotential data (EEG, EOG, EMG) step 205, data processing step 206, detection of SSEP step 207 and output of an action or control function step 208. Before utilizing the brain actuated control system of the present invention, the user 190 is prepared in step 201. This step consists of cleaning the scalp (forehead, occipital lobe region or other contact regions associated with Ag/Ag—Cl electrodes 140) by gently abrading with an appropriate preparation solution well known to anyone of ordinary skill in the art, cleaning the plurality of electrodes 140 with a mild soap solution or alcohol, placing the headgear on the head of user 190 and connecting the communications cable 116 to computer 110 and electrodes 140 to biopotential amplifier 150.

With the user connected to biopotential amplifier 150 the software 120 started whereupon calibration step 202 is subsequently performed. In this step, the software 120 automatically adjusts the amplifier gains and baselines to create an individualized signal envelope for one or more of the three analog biopotential types (EEG, EOG and EMG) transmitted through communications channel 155. This calibration step 202 maximizes the dynamic range of the signal and prevents high-end saturation for large potential swings while ensuring enough gain is applied for the proper amplification of the signal. It should be noted that general processing steps 201 and 202 can be performed by the user 190 alone or with the help of one or more assistants.

With the brain actuated control system 100 now prepared for use, step 203 is performed wherein software associated with controlling device 170 or software application 180 is started. In either case, the said software will render a virtual or mixed reality environment that user 190 can view and interact with via headgear 130. Headgear 130 optionally includes myriad sensors to facilitate this interaction including head position sensor 131, eye position sensor 132 and GPS sensor 133. These sensors can work alone or in conjunction with each other to provide control inputs to computer 110 and enable the user 130 to view and interact with the virtual/mixed environment in a natural way.

Next, step 204 presents one or more steady-state visual stimuli 135 to user 190. Visual stimuli 135 is typically associated in this step with, for example, a task (which could include making a selection from a menu or configuring some part of the virtual simulation), a function (which could include locomotion or interacting with some part of the virtual simulation), a person, place or thing, said thing could include for example a commercial offering 134. By way of example, step 204 could associate a visual stimulus 135 with a commercial offering in an e-commerce application. If a user 190 produced an SSEP associated with said stimulus, an action such as adding the commercial offering 134 to a shopping cart could be accomplished, for example. Likewise, said action could include obtaining more information about commercial offering 134.

Subsequent the presentation of one or more visual stimuli 135 in step 204, step 205 acquires biopotential data from user 190 via the electrodes 140, biopotential amplifier 150 and A/D 160. This data can include EEG, EOG and EMG biosignals. The data can further be stored, if needed, within computer 110 as described hereinabove. It will be apparent that since stimuli 135 is steady-state, steps 204 (presentation of the visual stimuli) and step 205 (acquisition of biopotential data) will take place simultaneously and repetitively until such time the stimuli 135 is altered or ceases. Similarly, software 120 may discontinue presentation of stimuli 135 (step 204) in the event an evoked potential is detected and appropriate action taken to obviate the need for further stimuli. For example, once a commercial offering 134 has been placed in a shopping cart, the associated stimuli 135 may cease.

Data processing step 206 of the present invention preferably utilizes a lock-in amplifier 500 as a digital signal processing technique the particulars of which are described hereinafter. After the user's 190 biopotential data is acquired it must be processed and analyzed to determine the presence or absence of an SSEP. The lock-in amplifier 500 can be implemented as part of software 120 in the form of an algorithm described in greater detail below and is well known to anyone of ordinary skill in the art, and for the preferred embodiment, functions as a very-high Q filter. The lock-in amplifier 500 computes a time-history of the power spectrum for a single predetermined frequency in near real-time. Multiple instantiations of lock-in amplifier 500 can be run concomitantly on computer 110, each with a unique pre-determined frequency. Since brain function produces signals that can be grouped into discrete bands of frequencies, the lock-in amplifier provides a way to discern information about what the brain is doing at any given point in time. The output signal of process step 206 is preferably in the form of an analog value the magnitude of which is representative of the strength of the SSEP resulting from the user 190 focusing his/her attention on stimuli 135. This signal is utilized by subsequent steps to determine the presence or absence of an evoked potential.

Processed data from step 206 is utilized by step 207 to make a determination with respect to the presence or absence of an SSEP in response to one or more visual stimuli 135. This step in its simplest form can be configured as a linear threshold detector wherein if the output signal level of lock-in amplifier 500 is greater than a pre-determined threshold value, the presence of an SSEP is indicated. Likewise if the output signal level of lock-in amplifier 500 is lower than a pre-determined threshold value, the absence of an SSEP is alternately confirmed. The algorithm utilized by step 207 can include non-linear methods, for example basing the decision of presence or absence of a steady-state evoked potential on the square of the output signal from lock-in amplifier 500, or setting multiple thresholds with different activities assigned to each of the ranges between said thresholds. Other variables can be taken in consideration by step 207 for example, head position, eye tracking and GPS location could all play a part in the detection process.

Finally, action or control function step 208 performs an activity relating to control of device 170 or software application 180 based on the determination made by detection step 207. This activity can be one or more of a myriad of things including controlling a device 170 such as an electromechanical device or instrument, for example an electronic musical keyboard, communication signaling device, media device, gaming device, or even another computer. Likewise step 208 could provide a control signal to a software application 180 of the present invention that could be any type of software program including, for example, a video game or other electronic game 181, an e-commerce application or website 182 or a computer pointing device 183. Step 208 could provide multiple control signals, for example, one type of control signal in the event step 207 detects an SSEP and another type of control signal in the event step 207 does not detect an evoked potential. By way of example, step 208 could provide a software instruction to a video game 181 causing a virtual or mixed reality character to run, jump, duck or fight for example. While these foregoing steps outline an exemplar method to implement the brain actuated control system of the present invention, they are not intended to limit the scope of the present invention. It will be readily apparent to those of ordinary skill in the art that myriad combinations and permutations of the steps detailed hereinabove can be employed in a suitable fashion to substantially derive the same or similar outcomes.

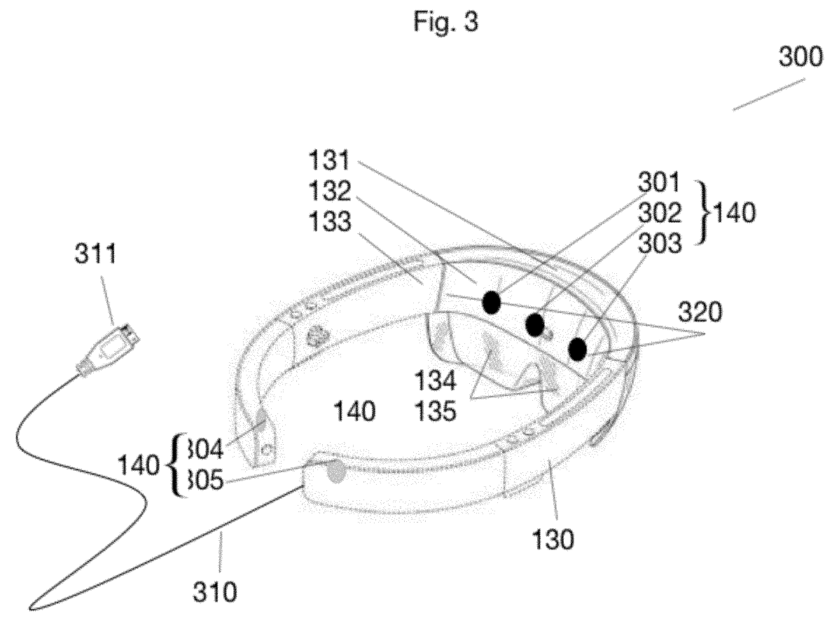

Reference is now made to FIG. 3, an exploded view of a representation 300 of the headgear 130 of the present invention. As can be seen in the drawing, the headgear 130 consists of MR or VR “goggles” which can be one of many known by those of ordinary skill in the art and commercially available under the trademarks “HoloLens®” or “Magic Leap™” for example, and may include a head position sensor 131, eye tracking sensor 132 and GPS locator 133. The headgear 130 may have one of, all of, or none of the foregoing sensors and still be used by the present invention. In addition to the aforementioned sensors, a plurality of electrodes 140 preferably of the Ag/Ag—Cl type are arrayed along the front (301-303) and back (304-305) of headgear 130 in such a way as to permit contact with the scalp of a user 190 when the headgear 130 is placed on the head of said user 190. The present invention could be used with as few as two electrodes but preferably has three or more electrodes in contact with the scalp of user 190. The electrodes 140 can be of any desirable shape or size provided they fit within the confines of the headgear 130. For the present invention, the preferable shape of the electrodes 140 is round and the preferable size range is between 0.250″ and 0.750″. Smaller or larger electrodes are perfectly acceptable as long as they are able to have adequate contact with the user's 190 scalp and provide a usable signal without creating excessive noise. A flexible cable 310 and multi-contact connector 311 are provide to connect electrodes 140 to biopotential amplifier 150 described in detail hereinabove. The electrodes 140 can be of a permanent or replaceable type enabling the user to renew one or more electrodes that have developed wear, corrosion or another defect making them unsuitable for use with the present invention. The electrodes can be positioned to contact various areas of interest of the scalp as a means to collect aggregate EEG, EOG and EMG data underlying the electrode's position on the scalp. For the present invention, it is preferred to locate electrodes 140 over the frontal (301-303) and occipital (304-305) regions of the brain, the occipital being particularly important when working with SSEPs. The electrodes 140 can be mounted directly to receptacles located on headgear 130, or can be mechanically attached to a separate head-band 320 that is removably attached to headgear 130. A separate headband 320 can be fabricated from a rigid material such as plastic, a semi-rigid material such as rubber or elastic, or a flexible material such as cloth or leather. The principal function of separate headband 320 is to hold the electrodes 140 respectively in stable proximity to each other and to specific locations on the user's scalp while minimizing the potential for artifact caused by movement of the electrodes over the surface of the scalp. The front edge of separate headband 320 is removably affixed to the front central portion, sides and rear portion of headgear 130. In this way, the headband 320 can be removed and periodically washed if needed. For the preferred embodiment of the present invention, the electrodes 140 are fabricated from Ag/Ag—Cl plated carbon-filled plastic. It will be evident to anyone of ordinary skill in the art that myriad other types of electrodes can be satisfactorily utilized by the brain actuated control system 100 including gold/gold-plated electrodes, for example. The front part of electrode array 140 is generally positioned above the Frontal lobe and across the forehead of user 190 with a reference electrode 302 preferably positioned above FPZ, signal electrode 301 preferably positioned above FP1 and signal electrode 303 preferably positioned above FP2 in accordance with the International “10-20” system. The rearward part of electrode array 140 is generally positioned above the Occipital lobe near the back of the head of user 190 with a signal electrode 304 preferably positioned above 01 and a signal electrode 305 positioned above 02 also in accordance with the “10-20” system for electrode placement.

Although there are many combinations and permutations for utilizing the above described electrode arrays 140, in general, electrode 302 which is centrally located within its respective array (301-303) is utilized as the “reference” electrode creating a common-mode rejection configuration to reduce global noise and artifacts. Electrodes 301-303 and 304-305 removably positionable on headgear 130 or separate headband 320 are electrically associated with cable 310 and connector 311. Lead wires attaching to individual electrodes 301-305 are combined to form the cable harness 310 which is preferably shielded to minimize extraneous electrical noise and interference. Cable 310 is preferably removably associated with biopotential amplifier 150 utilizing a common off-the-shelf connector 311 which is readily available and well known to anyone of ordinary skill in the art. Cable 310 is of a suitable length to permit headgear 130 to move freely without interference from any part of the system it is connected to. In this way, the biopotential signals from each of electrodes 301-305 making up electrode array 140 are communicated to biopotential amplifier 150 via cable 310.

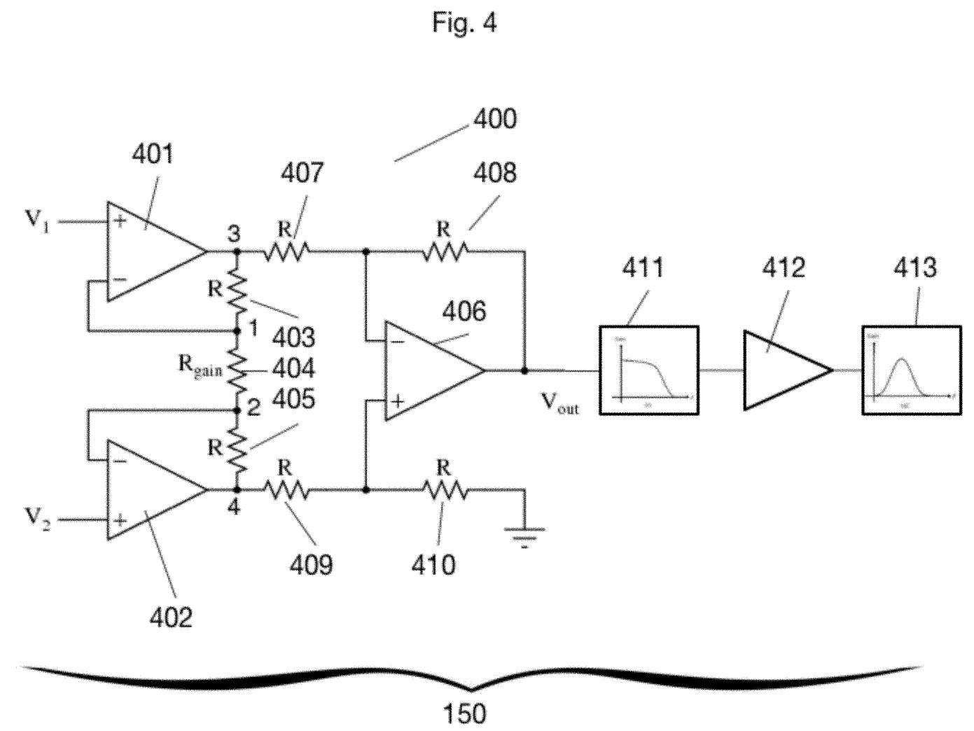

Referring now to FIG. 4, a circuit diagram representation 400 of one or more channels for biopotential amplifier 150 as described in detail hereinabove; it is desired that biopotential amplifier 150 have various characteristics conduce to the use of dry Ag/Ag—Cl electrodes which by necessity will have a very high contact impedance with the scalp. To that end, the biopotential amplifier 150 will require ultra-low internal noise specifications, e.g., input referred noise ≦22 nV/√Hz and input current noise ≦0.13 fA/√Hz. The amplifier must also utilize front-end active components with ultra-high input impedance, low current and low capacitance (≧10̂12Ω, input current ≦25 fA, input capacitance ≦1.5 pF). In addition, biopotential amplifier 150 must have excellent common-mode noise rejection. Accordingly, biopotential amplifier 150 is preferably configured as an “instrumentation amplifier”. The instrumentation amplifier “front-end” of biopotential amplifier 150 can be constructed from discrete components or can be a single integrated circuit, such as an AD-620 well known to anyone of ordinary skill in the art and commercially available under the trademark “Analog Devices®”, for example. The instrumentation amplifier of the present invention is constructed from a buffered differential amplifier stage 406 with three resistors 403-405 linking the two input buffer circuits 401 and 402 together. If resistors 403, 405 and 407-410 are of equal value, the negative feedback of the upper-left operational amplifier 401 will cause the voltage at point 1 (the junction of resistor 403 and resistor 404) to be equal to the input voltage from one of the signal electrodes 140 (designated V1). Likewise, the negative feedback of the lower-left operation amplifier 402 will cause the voltage at point 2 (the junction of resistor 404 and resistor 405) to be equal to the input voltage from another of the signal electrodes 140 (designated V2). This establishes a voltage drop across resistor 404 equal to the voltage difference between V1 and V2. That voltage drop causes a current through resistor 404 and since the feedback loops of the two input operational amplifiers 401 and 402 draw no current, that same amount of current through resistor 404 must be flowing through the resistor 403 and resistor 405 above and below it. This produces a voltage drop between points 3 and 4 equal to:

$${V}_{3 - 4} = ( {V}_{2} - {V}_{1} ) ( 1 + \frac{2 R}{{R}_{gain}} )$$

Operational-amplifier 406 configured as a standard differential amplifier on the right-middle of the circuit then takes this voltage drop between points 3 and 4 and amplifies it by a pre-determined gain factor. This instrumentation amplifier configuration has the distinct advantage of possessing extremely high input impedances on the V1 and V2 inputs (because they connect directly to the non-inverting inputs of their respective operational-amplifiers 401 and 402), and adjustable gain that can be selected by adjusting the value of a single resistor 404. Making use of the formula provided above, a general expression for overall voltage gain of the instrumentation amplifier is:

$${A}_{V} = ( 1 + \frac{2 R}{{R}_{gain}} )$$

It becomes apparent by viewing the schematic of FIG. 4. that the gain of the instrumentation amplifier could also be changed by changing the values of some of the other resistors. This, of course, would necessitate balanced resistor value changes in order for the circuit to remain symmetrical. Thus the gain of the amplifier is typically set by selecting a specific value for resistor 404 only. With respect to the present invention, a preferred value range of the gain of instrumentation amplifier 400 is between 10 and 40. Since the electrodes 140 are metalized and in contact with living tissue containing electrolytes, it is possible for the interaction to produce small voltages that will drive the operational amplifiers 401, 402 and 406 into saturation if the overall gain is set too high. In the present invention, the remaining stages of biopotential amplifier 150 are A.C. coupled to the instrumentation amplifier to prevent any D.C. offset voltages to be presented to succeeding stages. Since the biopotentials being amplified by biopotential amplifier 150 are in the order of 10̂-6 to 10̂-3 volts, additional gain and filtering stages are needed to produce a signal usable by the present invention. To that end, three exemplar follow-on stages are shown in FIG. 4. These stages include: low-pass filter 411, amplifier gain-stage 412 and band-pass filter 413. Low-pass filter 411 can be passive or active and is well known to anyone of ordinary skill in the art. Preferably a two-pole “Sallen-Key” type active filter using a single operational-amplifier would be used in the present invention as low-pass filter 411. Amplifier gain-stage 412 could be configured as one or more inverting or non-inverting operational-amplifiers each having a gain in the range of 10 to 100. For the present invention, the gain of amplifier 412 is preferably ˜50. Finally, a band-pass filter 413 can be employed and can be of many configurations well known in the art including a “Butterworth” filter, “Chebyshev” filter, or an “Infinite Gain Multiple Feedback” (IGMF) filter. The band-pass filter 413 can be configured to have any desired gain, or can be a unity-gain filter. Likewise, additional filtering or gain stages can be added sequentially to the signal chain of biopotential amplifier 150 the objective being to produce a conditioned signal suitable for use in effecting brain actuated control of the present invention.

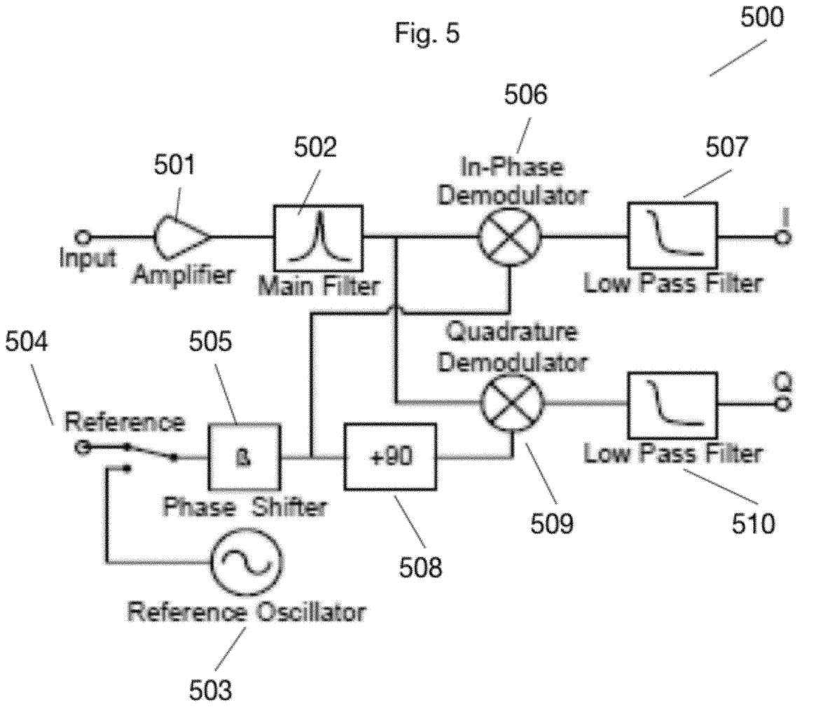

FIG. 5 depicts a block-diagram representation of a conventional “lock-in” amplifier 500 of the present invention. Lock-in amplifier 500 can be implemented utilizing hard-wired electronic components (hardware) or entirely as a software algorithm. The preferred embodiment of the present invention utilizes a software-derived lock-in amplifier system 500 to reduce parts count and associated cost; facilitate real-time changes to amplifier parameters; and, permit the creation of multiple instantiations of lock-in amplifier 500 at different frequencies without incurring additional cost. The lock-in amplifier system consists of an input amplifier stage 501 that increases the magnitude of the signal to a suitable level for further manipulation if necessary. Likewise, amplifier stage 501 could perform an impedance conversion in the process as well. In a hardware implementation, amplifier 501 could be a transistor circuit or operational-amplifier or the like; for a software implementation, amplifier 501 can be modeled by multiplying the discrete input signal by a constant gain factor “G”. A band-pass filter 502 can be employed to remove any signal components that are either at the D.C. level or at harmonics of the signal to be measured to help prevent aliasing. In a hardware implementation, band-pass filter 502 can be one of many well known to anyone of ordinary skill in the art and described in detail hereinabove; for a software implementation, band-pass filter 502 could be, for example, a software-derived Finite Impulse Response (FIR) filter or Infinite Impulse Response (IIR) filter, for example. The next stage of lock-in amplifier 500 is the in-phase demodulator 506 also known as a synchronous demodulator or simply “mixer”. This system element can take many forms, from a logarithmic amplifier to dedicated four-quadrant multiplier. In any case with either a hardware or software implementation, the processed input signal is multiplied by a reference signal from a sinusoidal oscillator 503 or an optional external reference 504 and a phase-shift element 505. Since the reference signal must maintain a fixed-phase relationship to the input signal, it can optionally be locked to the reference signal using a Phase-Locked Loop (PLL) (not shown). A quadrature demodulator 509 is also provided which mixes the processed input signal with a 90 degree phase-shifted version of the reference 508. This addition has the useful property that it is then quite simple to directly calculate the magnitude of the input signal and its phase relationship to the reference signal. These two separate “channels” are normally referred to as the “I” component and the “Q” component respectively. There are myriad electronic hardware components available and well known to anyone of ordinary skill in the art to implement the in-phase demodulator 506, quadrature demodulator 509 and 90 degree phase-shift element 508 of the present invention; for software, both demodulators and phase-shift element 508 can be implemented using simple trigonometric functions.

Finally, the output from the in-phase demodulator 506 and quadrature demodulator 509 are fed into low-pass filters 507 and 510 respectively which effectively removes any non-coherent signals leaving a D.C. signal that is proportional to the amplitude and phase of the original input signal with respect to the reference signal. Since the present invention is primarily concerned with the presence and magnitude of a visually evoked potential, the power spectrum for the input signal with respect to the reference signal can be derived as follows:

Mₚₛ=√(I²+Q²)

This signal can be utilized by processing step 207 of the present invention described in detail hereinabove to make a determination with respect to the presence or absence of a steady-state evoked potential.

As described above, the present invention can utilize either a hardware or software implementation of the lock-in amplifier system 500 but for the reasons given, a software implementation is preferred. There are a number of problems with analog lock-in amplifiers. For the highest accuracy, the reference signal must have a very low harmonic content. In other words, it must be a very pure sine wave since any additional harmonic content will likely cause distortion at the output. Analog sine wave generators can also suffer from frequency, amplitude and phase variations that would also introduce potentially distorting artifacts. On the other hand, a sine wave generator can be implemented in software simply by using a Sine or Cosine trigonometric function. Since the signal generated by said function is ideal, there can be no variation of frequency, amplitude or phase.

It is clear from the foregoing description that many variations, combinations and permutations of the various hardware and software elements described in FIG. 5. as part of lock-in amplifier system 500 could be employed in a suitable fashion to substantially derive the same or similar outputs. Therefore, the arrangement given is an exemplar method to implement the lock-in amplifier 500 of the brain actuated control system of the present invention and is not intended to limit the scope of the present invention.

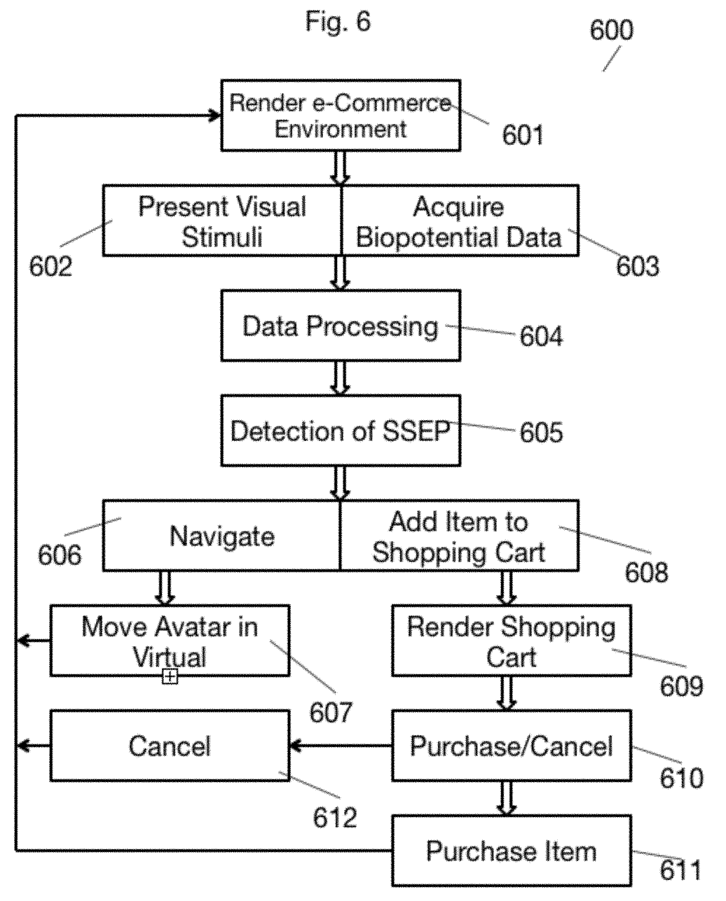

As shown particularly in FIG. 6, a flow diagram representation of the general processing steps 600 of another aspect of the present invention for virtual e-commerce applications includes: render e-commerce environment step 601, present visual stimuli step 602, acquire biopotential data step 603, data processing step 604, detection of SSEP step 605, navigate step 606, move avatar in virtual environment step 607, add item to shopping cart step 608, render shopping cart step 609, purchase/cancel step 610, purchase item step 611 and cancel step 612.

With the brain actuated control system 100 prepared for use as described in further detail hereinabove, step 601 is performed wherein software associated with an e-commerce application 182 is started. The e-commerce 3D simulation software will render a virtual or mixed reality environment that user 190 can view and interact with via headgear 130. Also as described above, headgear 130 optionally includes myriad sensors to facilitate this interaction including head position sensor 131, eye position sensor 132 and GPS sensor 133. These sensors can work alone or in conjunction with each other to provide control inputs to computer 110 and enable the user 130 to view and interact with the virtual/mixed environment in a natural way. It is expected that software 182 shall communicate with or be operating within a server that is distal from user 190. Accordingly it is within the scope of the present invention to render a shared virtual e-commerce environment with multiple users 190, each of whom would view the virtual e-commerce environment from a first-person perspective and would further view other human users 190, also within the shared environment, as a representative avatar. Thus, for example, it will be possible, within the scope of the present invention, for friends or family members to “shop” together and interact with each in the virtual or mixed e-commerce environment. In any event, step 601 is responsible for rendering this environment in all its complexity and detail. Likewise, step 601 is envisioned rendering a “mirror” within the virtual e-commerce environment that would permit user 190 to view his/her representative avatar. This feature would be especially useful to enable viewing oneself wearing virtual clothing, jewelry or makeup, for example.

Next, step 602 presents one or more steady-state visual stimuli 135 to user 190. Visual stimuli 135 are associated in this step with: navigational markers or beacons (waypoints) 710 within the virtual or mixed reality that will permit an avatar of user 190 to move about the simulation under a semblance of locomotion; and, commercial offerings 134 such as products or advertisements that user 190 can purchase by utilizing a virtual shopping cart designed particularly for such a purpose. For example, if a user 190 produced an SSEP associated with said stimuli, an action such as moving within the virtual/mixed environment or adding and/or purchasing a commercial offering 134 to a shopping cart could be accomplished. Likewise, said action could include obtaining more information about said commercial offering 134.

Subsequent the presentation of one or more visual stimuli 135 in step 602 step 603 acquires biopotential data from user 190 via the electrodes 140, biopotential amplifier 150 and A/D 160. This data can include EEG, EOG and EMG biosignals. The data can further be stored, if needed, within computer 110 as described hereinabove. It will be apparent that since stimuli 135 is steady-state, steps 602 (presentation of the visual stimuli) and step 603 (acquisition of biopotential data) will take place simultaneously and repetitively until such time the stimuli 135 is altered or ceases. Similarly, software 120 (possibly directed by software 182) may discontinue presentation of stimuli 135 (step 602) in the event an evoked potential is detected and appropriate action taken to obviate the need for further stimuli. For example, once a commercial offering 134 has been placed in a shopping cart, the associated stimuli 135 is no longer needed and may be discontinued.

Data processing step 604 of the present invention preferably utilizes a lock-in amplifier 500 as a digital signal processing technique the particulars of which are described in detail hereinabove. After the user's 190 biopotential data is acquired it must be processed and analyzed to determine the presence or absence of an SSEP. The lock-in amplifier 500 can be implemented as part of software 120 in the form of an algorithm described in greater detail above and is well known to anyone of ordinary skill in the art, and for the preferred embodiment, functions as a very-high Q filter. The lock-in amplifier 500 computes a time-history of the power spectrum for a single predetermined frequency in near real-time. Multiple instantiations of lock-in amplifier 500 can be run concomitantly on computer 110, each with a unique pre-determined frequency. Since brain function produces signals that can be grouped into discrete bands of frequencies, the lock-in amplifier provides a way to discern information about what the brain is doing at any given point in time. The output signal of process step 604 is preferably in the form of an analog value the magnitude of which is representative of the strength of the SSEP resulting from the user 190 focusing his/her attention on stimuli 135. This signal is utilized by subsequent steps to determine the presence or absence of an evoked potential.

Processed data from step 604 is utilized by step 605 to make a determination with respect to the presence or absence of an SSEP in response to one or more visual stimuli 135. This step in its simplest form can be configured as a linear threshold detector wherein if the output signal level of lock-in amplifier 500 is greater than a pre-determined threshold value, the presence of an SSEP is indicated. Likewise if the output signal level of lock-in amplifier 500 is lower than a pre-determined threshold value, the absence of an SSEP is alternately confirmed. The algorithm utilized by step 605 can include non-linear methods, for example basing the decision of presence or absence of a steady-state evoked potential on the square of the output signal from lock-in amplifier 500, or setting multiple thresholds with different activities assigned to each of the ranges between said thresholds. With respect particularly to the e-commerce embodiment of the present invention described herein, the output signal level from lock-in amplifier 500 could provide direct control over aspects of the simulation, for example, it could be used to set the speed of locomotion for user's 190 avatar. Other variables can be taken in consideration by step 605 for example, head position, eye tracking and GPS location could all play a part in the detection process.

While it is conceivable that myriad activities with respect to user 190 would be permissible within the scope of the virtual/mixed reality environment of the present invention, for purposes of this example, the forgoing discussion is limited to navigation/locomotion within the virtual space and the activity of adding/purchasing a commercial item to a virtual shopping cart. Navigation step 606 is responsible for providing the desired waypoints to which user 190 wishes to move. Step 607 subsequently produces the semblance of locomotion within the simulated e-commerce environment as a response to said navigation step 606. Navigation step 606 and move avatar step 607 permits user 190 to move about the virtual environment and view said environment from various first-person perspectives. This includes viewing the construction of the virtual space itself, such as visiting individual “shops” or “stores” (e.g., a “mall” environment) or observing commercial offerings within the environment such as products, advertisements and the like. In any case, step 606 has the primary function of identifying navigational markers or beacons (waypoints) 710 to which user 190 wishes to move when user 190 produces an SSEP in response to a stimuli associated therewith. It should be noted that while the preferred embodiment described herein uses SSEPs to facilitate navigation within the simulated environment, it is also feasible to utilize other biopotential signals obtained from user 190, such as EMG signals to accomplish the same function. Accordingly, the foregoing description is not intended to limit the scope of the present invention.

Each time any user 190 moves within or moves an object, such as a commercial offering, within said virtual e-commerce environment, the rendering of the environment and follow-on steps will be repeated in a loop as denoted by the various arrows in the flow diagram depicted in FIG. 6.

Once user 190 has completed the desired navigation/locomotion steps 606 and 607 respectively and desires to purchase, for example, a commercial offering 134 such as a product or service, step 608 provides the means by which said commercial offering can be added to a virtual shopping cart of the present invention. As described in detail hereinabove, one or more visual stimuli 135 can be associated with a commercial offering 134 that is identified and selected when user 190 produces an SSEP in response to said stimuli 135. Upon detection of an SSEP in response to a commercial offering in step 605, step 608 can add said commercial offering to a virtual shopping cart the particulars of which are described below. Step 609 renders the shopping cart in the 3D virtual space and step 610 provides options to the user that can be selected by using, for example, a computer pointing device controlled by head position. The options of step 610 can include, for example, immediate or delayed purchase of said commercial offering, providing a method of payment, selecting customizable product features, selecting product quantities or canceling the purchase altogether. At this stage in the process, the state of the virtual environment changes from a “navigational” to a “procurement” state with control of the simulation being passed to step 610.

Once the user 190 has made the various option selections provided via step 610 an affirmative decision to purchase the contents of the shopping cart, i.e., one or more commercial offerings 134, is processed by step 611. Step 611 is responsible for all tasks associated with the purchase including but not limited to, financial transactions, shipping arrangements, notification emails, and other such operations ancillary to the functioning of the e-commerce application. Having completed the purchase of one or more commercial offerings 134, the state of the virtual environment is switched by step 611 to a “navigational” state in a loop as denoted by the various arrows in the flow diagram shown in FIG. 6. Finally, in the alternative event user 190 elects to cancel the purchase, one or more commercial offerings 134 can be removed from the virtual shopping cart via cancel step 612. Subsequent the removal of one or more commercial offerings 134 from the shopping cart, step 612 having modified the desired configuration of the shopping cart, will likewise switch the state of the virtual environment back to a “navigational” state in a loop as denoted by the various arrows in the flow diagram shown in FIG. 6.

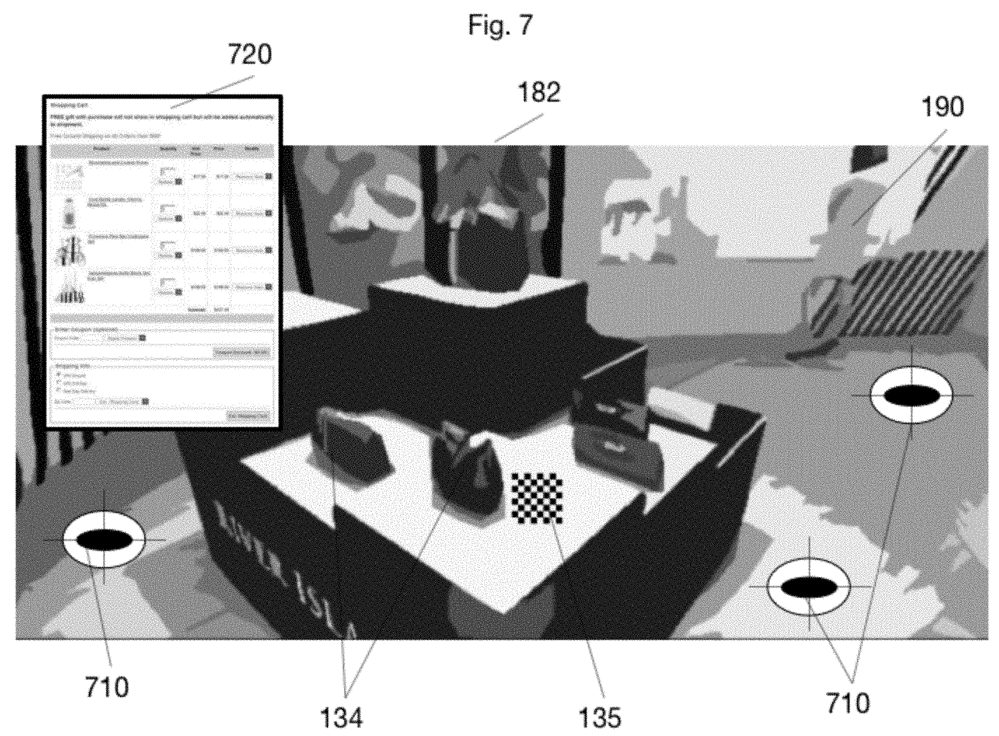

Reference is now made to FIG. 7 an exemplar of a 3D virtual representation of an e-commerce application and virtual shopping cart of the present invention. More particularly the representation is that of a virtual store wherein various commercial offerings 134 are depicted. Additionally, an avatar of another user 190 can be seen in the upper right of the representation. A virtual shopping cart 720 is depicted in the upper left of the representation. A number of navigational markers/beacons (waypoints) 710 are also shown. It should be noted that waypoints 710 can have fixed locations, i.e., they are bound within the virtual environment and do not change location or position with user 190 navigating from one point to the next. Likewise waypoints 710 can be moveable by user 190. A waypoint could, for example, be positioned within the virtual environment using one or more sensors on headgear 130 such as the head position sensor 131. In this scenario, the user 190 could position the waypoint at a desired location within the representation and upon “fixing” it at said desired location, the user 190 could locomote to that position whereupon subsequent navigation within the rendering could be accomplished if desired. As detailed above in steps 608-612 a virtual shopping cart representation 720 is depicted in FIG. 7. The shopping cart shown is an exemplar of its simplest form that being a traditional shopping cart such as would be associated with any typical e-commerce application. Many different configurations of shopping cart representation 720 could be implemented within the scope of the present invention including rendering it as a 3D model of a real shopping cart. In any case, regardless of the type or configuration of shopping cart 720, the user 190 will interact with said cart as described in steps 608-612 in order to facilitate the purchase of various commercial offerings 134 which include goods and services, for example.

The above described embodiments are set forth by way of example and are not for the purpose of limiting the scope of the present invention. It will be readily apparent to those or ordinary skill in the art that obvious modifications, derivations and variations can be made to the embodiments without departing from the scope of the invention. For example, the data processing and control program described in detail above as utilizing lock-in amplifier 500 could be one of many other algorithms well known to anyone of ordinary skill in the art. Likewise myriad signal processing techniques are known which could provide output signals substantially equivalent to those utilized by the present invention for example Discrete Fourier Transforms (DFTs), Phase Space Reconstruction, Hidden Markov Models, and Wavelet Analysis. Accordingly, the claims appended hereto should be read in their full scope including any such modifications, derivations and variations.

What is claimed is:

1. An apparatus for controlling a device utilizing electroencephalographic signals produced by brain activity in a user, the apparatus comprising:
a sensor adapted to be applied to a user for producing an input signal representing an aggregate of electroencephalographic biopotentials, said input signal changing in response to at least one of a steady-state visual stimuli;
an amplifier and analog-to-digital converter adapted to digitize said electroencephalographic biopotentials;
a signal processing algorithm responsive to said digitized signal and for generating at least one control signal, said control signal being associated with at least one of a visual stimuli;
a software algorithm responsive to said control signal for controlling at least one function of the device as a function of the changes in said control signal.

2. The brain actuated control apparatus of claim 1, wherein the device is an electromechanical device.

3. The brain actuated control apparatus of claim 1, wherein the device is an electronic musical keyboard.

4. The brain actuated control apparatus of claim 1, wherein the device is a communications device.

5. The brain actuated control apparatus of claim 1, wherein the device is a media device.

6. The brain actuated control apparatus of claim 1, wherein the device is a gaming device.

7. The brain actuated control apparatus of claim 1 wherein, the device is a computer.

8. An apparatus for controlling a software application utilizing electroencephalographic signals produced by brain activity in a user, the apparatus comprising:
a sensor adapted to be applied to a user for producing an input signal representing an aggregate of electroencephalographic biopotentials, said input signal changing in response to at least one of a steady-state visual stimuli;
an amplifier and analog-to-digital converter adapted to digitize said electroencephalographic biopotentials;
a signal processing algorithm responsive to said digitized signal and for generating at least one control signal, said control signal being associated with at least one of a visual stimuli;
a software algorithm responsive to said control signal for controlling at least one function of the software application as a function of the changes in said control signal.

9. The brain actuated control apparatus of claim 8 wherein the software application is a 3D virtual e-commerce application.

10. The brain actuated control apparatus of claim 9 wherein the user can move about within the 3D virtual e-commerce application.

11. The brain actuated control apparatus of claim 9 wherein the user can purchase a commercial offering.

12. The brain actuated control apparatus of claim 9 wherein the e-commerce application includes the ability to render the user wearing virtual clothing.
